(19) United States
(12) Patent Application Publication
(10) Pub. No.: US 2025/0163526 A1
(43) Pub. Date: May 22, 2025

(54) ELECTRIC GAS HEATING SYSTEM AND METHOD IN A DIRECT REDUCTION PLANT UTILIZING HYDROGEN OR NATURAL GAS

(71) Applicant: Midrex Technologies, Inc., Charlotte, NC (US)

(72) Inventors: Haruyasu Michishita, Charlotte, NC (US); Taiji Hatakeyama, Charlotte, NC (US)

(21) Appl. No.: 18/922,541

(22) Filed: Oct. 22, 2024

Related U.S. Application Data
(60) Provisional application No. 63/601,872, filed on Nov. 22, 2023.

(51) Int. Cl. C21B 13/00; C21B 13/02

(52) U.S. Cl. CPC C21B 13/0073; C21B 13/02; C21C 2100/04

(57) ABSTRACT

Direct reduction systems and methods utilize a direct reduction shaft furnace to reduce the iron oxide with a reduction gas received from a reduction/recycle gas loop. An electric gas heating system disposed in the reduction/recycle gas loop heats up the reduction gas with make-up hydrogen and/or natural gas before introducing to the shaft furnace. The gas heating system includes, in sequence, a primary gas heating unit utilizing a direct or indirect heating mechanism to first heat the reduction gas to a temperature below 600° C. or above 700° C. to avoid carbon deposition in the gas heating system and a secondary gas heating unit utilizing a direct heating mechanism to second heat the reduction gas to the temperature between 900° C. and 1100° C.

### CROSS-REFERENCE TO RELATED APPLICATION

The present disclosure claims the benefit of priority of co-pending U.S. Provisional Patent Application No. 63/601,872, filed on Nov. 22, 2023, and entitled “ELECTRIC GAS HEATING SYSTEM AND METHOD IN A DIRECT REDUCTION PLANT UTILIZING HYDROGEN,” the contents of which are incorporated in full by reference.

### TECHNICAL FIELD

The present disclosure relates generally to the direct reduced iron (DRI) and steelmaking fields. More specifically, the present disclosure relates to an electric gas heating system and method for heating the reduction gas introduced into a shaft furnace to reduce iron oxide to DRI in a direct reduction plant utilizing hydrogen and/or natural gas.

### BACKGROUND

As part of global efforts to combat climate change, the steel sector seeks to reduce its CO₂ emissions. In conventional steelmaking processes, the largest share of CO₂ emissions originates during the reduction of iron ore, where iron oxide is reduced to metallic iron with coal in the case of a blast furnace and natural gas in the case of a shaft furnace. In the case of direct reduction, hydrogen produced from green sources can serve as a replacement for natural gas, greatly diminishing emissions during the direct reduction phase of steelmaking.

In a state-of-art direct reduction process with hydrogen close to 100%, to minimize CO₂ emissions, an electrical heater driven by the green electricity is utilized to heat the reduction gas introduced into the shaft furnace to reduce the iron oxide. In responding to market demand to produce DRI containing carbon, a desirable property for downstream melting, some carbonaceous gas or material such as natural gas, biogas, and/or biocarbon needs to be introduced into the shaft furnace or the reduction gas loop. However, the carbon tends to deposit on the electric heater elements because the recycled reduction gas fed to the electric heater has a higher carburizing potential with CO. The carbon deposition may cause overheating or damage the electric heater unless the electric heater conducts a carbon burnout with the oxidized gas from time to time, when the plant must be idling with production stopped. Likewise, in a state-of-art direct reduction process with natural gas or natural gas partially replaced by hydrogen to produce the DRI containing carbon, where methane in natural gas is reformed in the shaft furnace and no external reformer is required to produce H2 and CO for reducing the iron oxide, the electric heater instead of fuel gas combustion heater could be utilized to heat the reduction gas and reduce CO2 emission. Then, the carbon may also deposit on the electric heater elements because the reduction gas has a higher carburizing potential with CO as well.

Accordingly, there is a need for improved systems and methods to prevent carbon deposition on the electrical heater elements when DRI containing carbon is produced in a direct reduction plant with an electrical heater utilizing hydrogen and/or natural gas to minimize CO₂ emissions.

### BRIEF SUMMARY

Embodiments of the present disclosure address the foregoing needs and others. Embodiments of the present disclosure improve upon prior systems and methods for producing DRI containing carbon and trying to minimize CO₂ emissions. For instance, it has been determined that an electric gas heater using the green electricity derived from renewable energy, which is also used to produce green hydrogen with electrolysis, can be used to reduce CO₂ emissions.

According to embodiments of the present disclosure, a system and method to produce DRI containing carbon utilizing hydrogen and/or natural gas includes a shaft furnace configured to reduce iron oxide to metallic iron with the reduction gas, where carbonaceous gas and/or carbonaceous solid material is introduced to the shaft furnace to produce the DRI containing carbon, wherein make-up hydrogen and/or natural gas is added to the recycled shaft furnace effluent gas and thereafter the recycled mixed gas comprising H2, H2O, CO, CO2, N2 and other carbonaceous gas is heated with electric gas heating units. The electric gas heating units include two (2) step electric gas heating units with separate power control to heat the recycled reduction gas, where the primary electric gas heating unit with a direct heating mechanism is configured to heat the reduction gas to a temperature about or below 600° C. to avoid the carbon formation temperature range with CO and the secondary electric gas heating unit with a direct heating mechanism is configured to heat the reduction gas to 900˜1100° C.

In some embodiments, the gas temperature after the primary electric gas heating unit is 500˜650° C.

In some embodiments, the electricity source for the electrics gas heating units is green electricity.

Also according to embodiments of the present disclosure, a system and method to produce DRI containing carbon utilizing hydrogen and/or natural gas includes a shaft furnace configured to reduce iron oxide to metallic iron with the reduction gas, where carbonaceous gas and/or carbonaceous solid material is introduced to the shaft furnace to produce the DRI containing carbon, where make-up hydrogen and/or natural gas is added to the recycled shaft furnace effluent gas and thereafter the recycled mixed gas comprising H2, H2O, CO, CO2, N2 and other carbonaceous gas is heated with electric gas heating units. The electric gas heating units include two (2) step electric gas heating units with separate power control to heat the recycled reduction gas, where the primary electric gas heating unit with an indirect heating mechanism is configured to heat the reduction gas to a temperature about or above 700° C. to avoid the carbon formation temperature range with CO and the secondary electric gas heating unit with a direct heating mechanism is configured to heat the reduction gas to 900˜1100° C.

In some embodiments, the temperature after the primary electric gas heating unit is 500˜700° C.

In some embodiments, the electricity source for the electrical gas heating units is green electricity.

Further according to embodiments of the present disclosure, a system and method to produce DRI containing carbon utilizing hydrogen and/or natural gas includes a shaft furnace configured to reduce iron oxide to metallic iron with the reduction gas, where carbonaceous gas and/or carbonaceous solid material is introduced to the shaft furnace to produce the DRI containing carbon, wherein make-up hydrogen and/or natural gas is added to the recycled shaft furnace effluent gas and thereafter the recycled mixed gas comprising H2, H2O, CO, CO2, N2 and other carbonaceous gas is heated. The gas heating units include two (2) step gas heating units with the separate heat control to heat the recycled gas, where the primary gas heating unit with an indirect heating mechanism using fuel combustion is configured to heat the hydrogen rich reduction gas to a temperature about or above 700° C. to avoid the carbon formation temperature range with CO and the secondary electric gas heating unit with a direct heating mechanism is configured to heat the reduction gas to 900˜1100° C.

In some embodiments, the temperature after the primary gas heating unit is 500˜700° C.

In some embodiments, the electricity source for the secondary electric gas heating unit is green electricity.

It is noted that state-of-the-art direct reduction systems with electric heating of the reduction gas may have an issue in producing DRI containing carbon, a desirable property for downstream melting. In such cases, with the DRI containing carbon produced in the direct reduction plant with hydrogen close to 100%, hydrocarbon gas, such as biogas or natural gas, or bio-carbon material is introduced into the shaft furnace, typically the lower portion of the shaft furnace, to carburize the material after reduction. Then, the carbonaceous gas compounds such as CO, CO₂, and CH₄ together with H₂ and N₂ are recycled and the reduction gas fed to the electric heating system which heats the reduction gas up to the higher temperature (900˜1100° C.) to drive the subsequent iron oxide reduction in the shaft furnace. Likewise, in a state-of-art direct reduction process with natural gas or natural gas partially replaced by hydrogen to produce the DRI containing carbon, where methane in natural gas is reformed in the shaft furnace to produce H2 and CO for reducing the iron oxide, the recycled reduction gas having the higher carburizing potential with CO is fed to the electric heating system to heat the reduction gas up to the higher temperature (900˜1100° C.) to drive the subsequent iron oxide reduction reaction in the shaft furnace. In these cases, carbon may tend to deposit on the electric heater elements when the recycled gas having the higher carburizing potential with CO is heated up to above 600° C., more specifically in the temperature range from about 600 to 700° C. This carbon deposition may cause the carbon buildup or carbon corrosion (metal dusting) for the electric heater elements to deteriorate the heating performance or shorten the life in case the gas is heated directly with the heater element. The carbon deposition issue may be prevented if an indirect heater system is applied. But the direct heating mechanism for the electric gas heating system has the advantage of achieving the higher temperature (900˜1100° C.) due to higher heat transfer performance or minimizing the element operation temperature with a small approach temperature (the temperature difference between the element and the heated gas) to extend the element life.

To resolve these issues, the carbon deposition on the electric heating element in the direct heating electric heating system can be burnt out with oxidized gas such as air, steam, or the oxidized gas including H₂O, CO₂, and O₂. However, the burn out must take place during the idling period without DRI in the shaft furnace. Plant availability thus decreases when the carbon burnout is executed to manage the carbon deposition from time to time.

Thus, in some embodiments, the present disclosure advantageously provides an electric gas heating system to heat the reduction gas having carburizing potential with CO from ambient to 900˜1100° C. in a direct reduction plant with make-up hydrogen and/or natural gas. Advantageously, with the electric heating system circumventing the problematic temperature range between 600° C. and 700° C. where the carbon depositing reaction is active with the higher carburizing potential gas with CO, the system and method eliminate the carbon burnout process involving plant idling, which results in higher plant availability with the electric gas heating system with the direct heating mechanism.

In some embodiments, the present disclosure provides two (2) step electric gas heating systems, where the heater element temperature at the secondary electric gas heating system with a direct heating mechanism is maintained above about 700° C., beyond the carbon depositing temperature range, by applying a secondary feed gas temperature high enough without generating the carbon deposition at the primary electric gas heating system. The secondary step should apply the direct heating mechanism to minimize the approach temperature and extend the heater element life to achieve higher temperatures of 900˜1100° C.

In some embodiments, two (2) electric gas heating units with a direct heating mechanism but separate power controls are applied, where the primary unit heats the reduction gas to the temperature just below 600° C. to avoid the carbon formation temperature range with CO between 600° C. and 700° C. and is followed by the secondary unit heating the reduction gas to 900˜1100° C. The gas temperature around 600° C. after the primary units ensures the surface temperature of the electric heater element above 700° C. at the secondary unit. The temperature of the heating element, such as an electric wire in the direct gas heating unit, is always higher than the heated gas temperature, which allows the element temperature to be higher than 700° C. even if the gas temperature is 600° C., for example.

In some embodiments, two (2) electric gas heating units with separate power controls are applied, where the primary unit heats the reduction gas to a temperature above 700° C. with an indirect heating mechanism to avoid the carbon formation temperature range with CO between 600° C. and 700° C. and is followed by the secondary unit with a direct heating mechanism heating the reduction gas to 900˜1100° C. This is more advantageous in case the carburization potential of the heated gas is high with higher CO content and/or less oxidant (H₂O or CO₂) content.

In some embodiments, two (2) gas heating units with separate heating controls are applied, where the primary unit heats the reduction gas to a temperature above 700° C. with an indirect heating mechanism using fuel combustion to avoid the carbon formation temperature range with CO between 600° C. and 700° C. and is followed by the secondary unit with a direct heating mechanism heating the reduction gas to 900˜1100° C. This is also more advantageous in case the carburization potential of the heated gas is high with higher CO content and/or less oxidant (H₂O or CO₂) content. Furthermore, this is advantageous in case the top gas fuel is discharged from the reduction gas loop but not used by anyone or green fuel such as biogas is available as the combustion fuel.

In some embodiments, a direct reduction system includes a direct reduction shaft furnace adapted to reduce iron oxide to form direct reduced iron in the presence of a reduction gas received from a reduction/recycle gas loop and a gas heating system disposed in the reduction/recycle gas loop and adapted to output the reduction gas to the direct reduction shaft furnace at a temperature of between 900° C. and 1100° C. The gas heating system includes, in sequence, a primary gas heating unit utilizing a primary direct heating mechanism or a primary indirect heating mechanism to first heat the reduction gas to a temperature below 600° C. or above 700° C. to avoid carbon deposition in the gas heating system at a temperature between 600° C. and 700° C. and a secondary gas heating unit utilizing a secondary direct heating mechanism to second heat the reduction gas to the temperature of between 900° C. and 1100° C.

In some embodiments, the primary direct heating mechanism includes an electric heating element to which the reduction gas is exposed.

In some embodiments, the primary indirect heating mechanism includes an electric heating element disposed within a tube such that the electric heating element is not exposed to the reduction gas.

In some embodiments, the primary indirect heating mechanism includes a gas burner adapted to heat the reduction gas. The gas burner utilizes top gas fuel derived from the reduction/recycle gas loop or green fuel derived from an external source.

In some embodiments, the secondary direct heating mechanism includes an electric heating element to which the reduction gas is exposed. The electric heating element may be maintained at a temperature above 700° C. to avoid carbon deposition in the secondary gas heating unit.

In some embodiments, the reduction gas is maintained at the temperature below 600° C. or above 700° C. between the primary gas heating unit and the secondary gas heating unit to avoid carbon deposition in the gas heating system.

In some embodiments, the reduction gas received from the reduction/recycle gas loop includes top gas derived from the direct reduction shaft furnace.

In some embodiments, the direct reduction system also includes a scrubber and a compressor disposed in the reduction/recycle gas loop between the direct reduction shaft furnace and the gas heating system.

In some embodiments, a direct reduction method includes heating reduction gas utilizing a gas heating system disposed in a reduction/recycle gas loop and outputting the reduction gas to a direct reduction shaft furnace at a temperature of between 900° C. and 1100° C., where the gas heating system includes, in sequence, a primary gas heating unit utilizing a primary direct heating mechanism or a primary indirect heating mechanism to first heat the reduction gas to a temperature below 600° C. or above 700° C. to avoid carbon deposition in the gas heating system at a temperature between 600° C. and 700° C. and a secondary gas heating unit utilizing a secondary direct heating mechanism to second heat the reduction gas to the temperature of between 900° C. and 1100° C. The direct reduction method also includes, in the direct reduction shaft furnace, reducing iron oxide to form direct reduced iron in the presence of the reduction gas received from the reduction/recycle gas loop.

In some embodiments, the direct reduction method further includes maintaining the reduction gas at the temperature below 600° C. or above 700° C. between the primary gas heating unit and the secondary gas heating unit to avoid carbon deposition in the gas heating system.

In some embodiments, the direct reduction method further includes cleaning and compressing the reduction gas utilizing a scrubber and a compressor disposed in the reduction/recycle gas loop between the direct reduction shaft furnace and the gas heating system.

It will be readily apparent to those of ordinary skill in the art that elements, limitations, aspects, and characteristics of the various embodiments of the present disclosure may be included, omitted, and combined as desired in a given application, without limitation.

### BRIEF DESCRIPTION OF THE DRAWINGS

The present disclosure is illustrated and described with reference to the various drawings, in which like reference numbers are used to denote like system/assembly components or method steps, as appropriate, and in which:

FIG. 1 is a schematic diagram/flowsheet illustrating a prior direct reduction system and method with make-up hydrogen and/or natural gas, where the (recycled) reduction gas is heated with a single electric heating system using a direct heating mechanism;

FIG. 2 is a schematic diagram/flowsheet illustrating an embodiment of the present disclosure for a direct reduction system and method with make-up hydrogen and/or natural gas, where the (recycled) reduction gas is heated with two (2) step electric heating systems with separate power controls, both primary and secondary electric heating systems using a direct heating mechanism;

FIG. 3 is a schematic diagram/flowsheet illustrating an embodiment of the present disclosure for a direct reduction system and method with make-up hydrogen and/or natural gas, where the (recycled) reduction gas is heated with two (2) step electric heating systems with separate power controls, the primary electric heating system using an indirect heating mechanism and the secondary electric heating system using a direct heating mechanism; and

FIG. 4 is a schematic diagram/flowsheet illustrating an embodiment of the present disclosure for a direct reduction system and method with make-up hydrogen and/or natural gas, where the (recycled) reduction gas is heated with two (2) step electric heating systems with separate power controls, the primary electric heating system using a fuel combustion indirect heating mechanism and the secondary electric heating system using a direct heating mechanism.

It will be readily apparent to those of ordinary skill in the art that elements, limitations, aspects, and characteristics of the various drawings of the present disclosure may be included, omitted, and combined as desired in a given application, without limitation.

### DETAILED DESCRIPTION

Again, in various exemplary embodiments, the present disclosure advantageously provides an efficient reduction gas heating system with higher operability in a direct reduction plant utilizing hydrogen close to 100% and/or natural gas to produce the DRI containing carbon. In the direct reduction plant utilizing hydrogen close to 100%, the electric gas heater may use electricity derived from renewable energy, which is also used to produce green hydrogen with electrolysis, for example, to reduce CO₂ emissions.

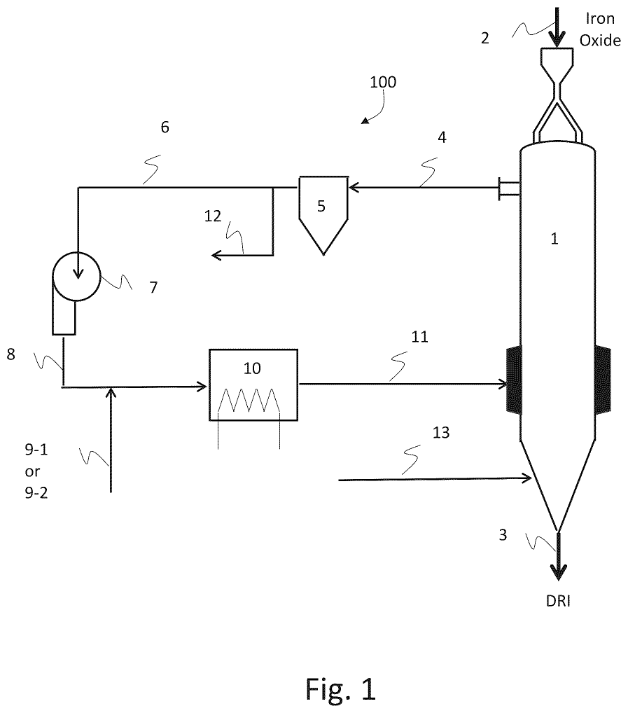

FIG. 1 shows a prior direct reduction system/method using hydrogen close to 100% when make-up H₂ 9-1 is applied, a prior direct reduction system/method using natural gas when make-up natural gas 9-2 is applied or a prior direct reduction system/method using natural gas partially replaced by hydrogen when both make-up hydrogen 9-1 and make-up natural gas 9-2 is applied. The shaft furnace 1 receives iron oxide 2 at the top of the shaft furnace 1 and discharges product DRI 3 from the bottom of the shaft furnace 1 after direct reduction in the shaft furnace 1. The shaft furnace top gas 4, which is the spent gas after the direct reduction of the iron oxide 2, contains reaction products such as H₂O and CO₂ as well as the unused reductant such as H₂, CO, and CH₄ and is recycled or recirculated through the reduction/recycle gas loop 100. After the top gas 4 is cooled and cleaned with a scrubber 5, most of the cooled and cleaned gas 6 is recycled to the shaft furnace 1 since it still contains H₂ and CO, while what is called the top gas fuel 12 is partially removed to prevent the accumulation of inert N₂ and CO₂ in the reduction/recycle gas loop 100. In case of the direct reduction with hydrogen close to 100%, make-up H₂ 9-1 is added to the compressed gas 8 after compression of the cooled and cleaned gas 6 in a compressor 7. In case of the direct reduction with natural gas, make-up natural gas 9-2 is added to the compressed gas 8 after compression of the cooled and cleaned gas 6 in a compressor 7, wherein methane in the natural gas is reformed catalytically with the direct reduction iron to produce H2 and CO to reduce the iron oxide simultaneously in the shaft furnace.

After the addition of make-up hydrogen and/or natural gas to the compressed mixed gas after the compressor 7, the electric heating system 10 which is a single unit using a direct heating mechanism will heat the cold mixed gas to a higher temperature (900˜1100° C.) required for the iron oxide reaction in the shaft furnace 1. Here, the direct heating mechanism incorporates an electric heating element that is in direct contact with the heated gas, with heating controlled by a heating control system. The heated reduction gas 11 exiting the electric heating system 10 is fed to the shaft furnace 1.

With the hydrogen reduction case to minimize CO2 emission, in response to market demand to produce DRI containing carbon, a desirable property for downstream melting, carburizing gas 13, which is carbonaceous gas such as natural gas, biogas, and/or the product gas from biocarbon gasification, may be introduced into the lower part of the shaft furnace 1 to carburize the material after being reduced in the upper part of the shaft furnace 1. Furthermore, biocarbon material could be fed with the iron oxide 2 to the shaft furnace 1 to produce such DRI 3 containing carbon.

In such cases, the introduced carbon agent carburizes the DRI 3 but partially slips to form CO, CO₂, and CH₄ in the shaft furnace 1. These carbonaceous gas compounds are discharged together with H₂, H2O and N₂ in the top gas 4 and eventually recycled to the electric heating system 10. The carbon may tend to deposit on the electric heating elements of the electric heating system 10 in the reduction/recycle gas loop 100 the recycled gas 4,6,8 having the higher carburizing potential with CO is heated up to above 600° C., more specifically in the temperature range from 600 to 700° C. This carbon deposition may cause carbon buildup or carbon corrosion (metal dusting) for the electric heating elements and deteriorate their heating performance and/or shorten their life in the case that the recycled gas 4,6,8 is heated with the direct heating mechanism. The carbon deposition may damage the electric heating elements due to overheating of the electric heating elements covered with carbon. The gas passages around the electric heating elements might also be plugged as the carbon deposition grows. Typically, the direct heating mechanism is applied to heat the process gas to the higher temperature (900˜1100° C.) because direct heating with the electric heating elements achieves higher heat transfer and/or minimizes electric heating element operation temperature with the associated small approach temperature to extend the electric heating element life.

With the natural gas reduction case reforming methane to produce H2 and CO to reduce the iron oxide simultaneously in the shaft furnace, the recycled gas 4,6,8 having even higher carburizing potential is eventually recycled to the electric heating system 10, where the carbon tends to deposit on the electric heating elements of the electric heating system 10.

The carbon deposition in the electric heating system 10 can be burned out with oxidized gas such as air, steam, or oxidized gas including H₂O, CO₂, and/or O₂. However, these oxidized gases cannot be introduced on-line or during the normal production period since the gasses oxidize the DRI 3 and cause clustering in the shaft furnace 1. Therefore, the burnout process must take place off-line or during idling periods without the DRI 3 retained in the shaft furnace 1. Thus, plant availability decreases when carbon burnout is executed to manage the carbon deposition from time to time.

Thus, in embodiments, the present disclosure provides an electric gas heating system to heat the recycled reduction gas with make-up hydrogen and/or natural gas having the above carburizing potential with CO from ambient to 900˜1100° C. in the direct reduction plant utilizing hydrogen close to 100% and/or natural gas. Advantageously, the electric gas heating system eliminates the above carbon burnout problem and the plant idling, which results in higher plant availability, with the electric gas heating system with the desired direct heating mechanism.

In various embodiments, the present disclosure provides an electric gas heating system to heat the recycled reduction gas with make-up hydrogen and/or natural gas having the above carburizing potential with CO from ambient to 900˜1100° C. to prevent the above carbon deposition in the electric gas heating system. More specifically, embodiments of present disclosure provide two (2) step electric gas heating systems, where the heating element temperature at the secondary step electric gas heating system with direct heating mechanism is maintained above about 700° C., beyond the carbon deposition temperature range, by applying the electric gas heating system not to generate carbon at the primary step. The secondary step applies the direct heating mechanism to minimize element operation temperature with a small approach temperature to extend the heating element life at higher temperatures of 900˜1100° C. at the outlet.

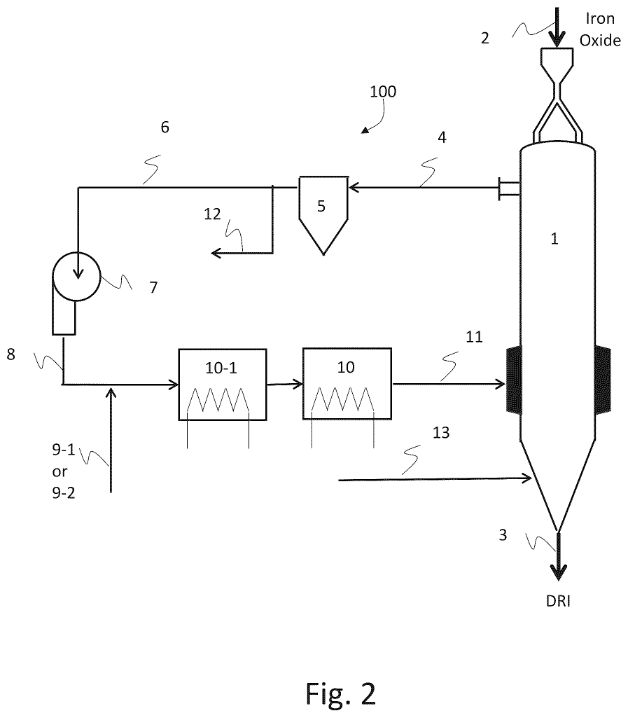

Referring to FIG. 2, with most aspects similar to FIG. 1, two (2) electric gas heating units 10-1 and 10 are used in sequence, both with a direct heating mechanism using the electric heating elements exposed to the heated gas, but with separate power controls. The primary electric gas heating unit 10-1 heats the recycled reduction gas with make-up hydrogen and/or natural gas to a temperature just at or below 600° C. to avoid the carbon formation temperature range with CO between 600° C. and 700° C. and is followed by the secondary electric gas heating unit 10 heating the reduction gas to 900˜1100° C. At the secondary electric gas heating unit 10, the surface temperature of the electric heating element can be maintained above 700° C. to mitigate carbon deposition when the gas temperature entering the secondary electric gas heating unit 10 is just at or below 600° C. The temperature of the electric heating element, such as an electric wire in the direct gas heating unit, is always higher than the heated gas temperature, which allows the heating element temperature to be higher than 700° C. even if the gas temperature is 600° C. Because of this temperature control, no carbon is generated in the primary electric gas heating unit 10-1 that is below the carbon formation temperature range with CO. Proper sizing of the tube or gas velocity around the electric heating element of the secondary electric gas heating unit 10 maintains the appropriate gas boundary film or approach temperature, which ensures that the gas forms no carbon at the inlet of the secondary electric gas heating unit 10.

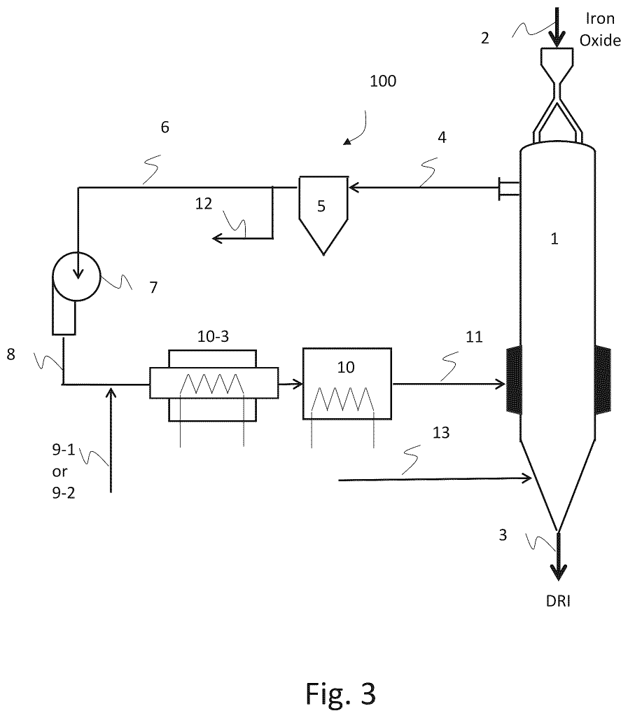

Referring to FIG. 3, with most aspects similar to FIGS. 1 and 2, two (2) electric gas heating units 10-3 and 10 with the separate power controls are applied, where the primary electric gas heating unit 10-3 heats the recycled reduction gas with make-up hydrogen and/or natural gas to a temperature at or above 700° C. with an indirect heating mechanism and is followed by the secondary electric gas heating unit 10 heating the reduction gas to 900˜1100° C. FIG. 3 is more advantageous than FIG. 2 in the case that the carburization potential of the heated gas is too high with higher CO content and/or less oxidant (H₂O or CO₂) content. In the primary electric gas heating unit 10-3, a ceramic tube or an metallic tube with the ceramic or refractory lining isolates the electric heater element from the carburizing gas, flowing inside the tube heated by the electric heating element located outside the tube or flowing outside of the tube heated by the electrical heating element located inside the tube, to avoid the carbon formation with CO taking place in the temperature range between 600° C. and 700° C. The gas temperature entering the secondary electric gas heating unit 10 exceeding 700° C. ensures that the gas forms no carbon in the secondary electric gas heating unit 10.

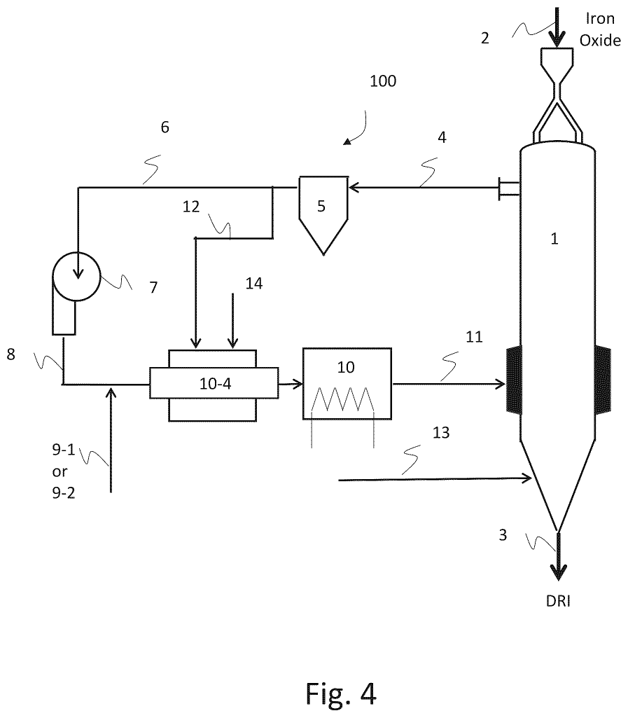

Referring to FIG. 4, with most aspects similar to FIGS. 1-3, two (2) gas heating units 10-4 and 10 with separate power controls are applied, where the primary gas heating unit 10-4 heats the recycled reduction gas with make-up hydrogen and/or natural gas to a temperature at or above 700° C. with an indirect heating mechanism using fuel combustion and is followed by the secondary electric gas heating unit 10 heating the reduction gas to 900˜1100° C. FIG. 4 is more advantageous than FIG. 2 in the case that the carburization potential of the heated gas is too high with higher CO content and/or less oxidant (H₂O or CO₂) content. In the primary electric gas heating unit 10-4, a ceramic or alloy tube isolates the fuel combustion burner system located outside the tube from the carburizing gas flowing inside of the tube to avoid the carbon formation with CO taking place at the temperature range between 600° C. and 700° C. The gas temperature entering the secondary electric gas heating unit 10 exceeding 700° C. ensures that the gas forms no carbon in the secondary electric gas heating unit 10. The burner fuel for the primary gas heating unit 10-4 may be the top gas fuel 12 discharged from the reduction/recycle gas loop 100 and/or a green fuel, such as biogas, that is combusted with combustion air 14. FIG. 4 is preferable in the case that the top gas fuel 12 is discharged but not used or the green fuel, such as biogas, is readily available. It may be likely that the amount of top gas fuel 12 and biogas available at the direct reduction plant is not enough to heat all the recycled reduction gas to 900˜1100° C. without use of the secondary electric gas heating unit 10.

Thus, again, in various exemplary embodiments, the present disclosure advantageously provides an efficient reduction gas heating system with higher operability in a direct reduction plant utilizing hydrogen close to 100% and/or natural gas to produce the DRI containing carbon. In the direct reduction plant utilizing hydrogen close to 100% and/or natural gas, the electric gas heater may use electricity derived from renewable energy, which is also used to produce green hydrogen with electrolysis, for example, to reduce CO₂ emissions.

Although the present disclosure is illustrated and described with reference to particular embodiments and specific examples thereof, it will be readily apparent to those of ordinary skill in the art that other embodiments and examples may perform similar functions and/or achieve like results. All such equivalent embodiments and examples are within the spirit and scope of the present invention, are contemplated thereby, and are intended to be covered by the following non-limiting claims for all purposes. Moreover, all features, elements, and embodiments described may be used in any combination, without limitation.

What is claimed is:

1. A direct reduction system comprising:
a direct reduction shaft furnace adapted to reduce iron oxide to form direct reduced iron in the presence of a reduction gas received from a reduction/recycle gas loop; and
a gas heating system disposed in the reduction/recycle gas loop and adapted to output the reduction gas to the direct reduction shaft furnace at a temperature of between 900° C. and 1100° C., wherein the gas heating system comprises in sequence:
a primary gas heating unit utilizing a primary direct heating mechanism to first heat the reduction gas to a temperature below 600° C. or a primary indirect heating mechanism to first heat the reduction gas to a temperature below 600° C. or above 700° C. to avoid carbon deposition in the gas heating system at a temperature between 600° C. and 700° C.; and
a secondary gas heating unit utilizing a secondary direct heating mechanism to second heat the reduction gas to the temperature of between 900° C. and 1100° C.

2. The direct reduction system of claim 1, wherein the primary direct heating mechanism comprises an electric heating element to which the reduction gas is exposed.

3. The direct reduction system of claim 1, wherein the primary indirect heating mechanism comprises an electric heating element disposed inside or outside a tube to isolate the electric heating element from the heated reduction gas flowing in the opposite side of the tube.

4. The direct reduction system of claim 1, wherein the primary indirect heating mechanism comprises a gas burner disposed outside of a tube to isolate the burner system from the heated reduction gas flowing in the opposite side of the tube.

5. The direct reduction system of claim 4, wherein the gas burner utilizes top gas fuel derived from the reduction/recycle gas loop or green fuel derived from an external source.

6. The direct reduction system of claim 1, wherein the secondary direct heating mechanism comprises an electric heating element to which the reduction gas is exposed.

7. The direct reduction system of claim 6, wherein the electric heating element is maintained at a temperature above 700° C. to avoid carbon deposition in the secondary gas heating unit.

8. The direct reduction system of claim 1, wherein the reduction gas is maintained at the temperature below 600° C. or above 700° C. between the primary gas heating unit and the secondary gas heating unit to avoid carbon deposition in the gas heating system.

9. The direct reduction system of claim 1, wherein the reduction gas received from the reduction/recycle gas loop comprises top gas derived from the direct reduction shaft furnace.

10. The direct reduction system of claim 1, further comprising a scrubber and a compressor disposed in the reduction/recycle gas loop between the direct reduction shaft furnace and the gas heating system.

11. A direct reduction method comprising:
heating reduction gas utilizing a gas heating system disposed in a reduction/recycle gas loop and outputting the reduction gas to a direct reduction shaft furnace at a temperature of between 900° C. and 1100° C., wherein the gas heating method comprises in sequence:
first heating the reduction gas to a temperature below 600° C. utilizing a primary direct heating mechanism or first heating the reduction gas to a temperature below 600° C. or above 700° C. utilizing a primary indirect heating mechanism to avoid carbon deposition in the gas heating system at a temperature between 600° C. and 700° C.; and
second heating the reduction gas to the temperature of between 900° C. and 1100° C. utilizing a secondary direct heating mechanism; and
in the direct reduction shaft furnace, reducing iron oxide to form direct reduced iron in the presence of the reduction gas received from the reduction/recycle gas loop.

12. The direct reduction method of claim 11, wherein the primary direct heating mechanism comprises an electric heating element to which the reduction gas is exposed.

13. The direct reduction method of claim 11, wherein the primary indirect heating mechanism comprises an electric heating element disposed inside or outside a tube such that the electric heating element is not exposed to the reduction gas flowing in the opposite side of the tube.

14. The direct reduction method of claim 11, wherein the primary indirect heating mechanism comprises a gas burner adapted to heat the reduction gas.

15. The direct reduction method of claim 14, wherein the gas burner utilizes top gas fuel derived from the reduction/recycle gas loop or green fuel derived from an external source.

16. The direct reduction method of claim 11, wherein the secondary direct heating mechanism comprises an electric heating element to which the reduction gas is exposed.

17. The direct reduction method of claim 16, wherein the electric heating element is maintained at a temperature above 700° C. to avoid carbon deposition in the secondary gas heating unit.

18. The direct reduction method of claim 11, further comprising maintaining the reduction gas at the temperature below 600° C. or above 700° C. between the primary gas heating unit and the secondary gas heating unit to avoid carbon deposition in the gas heating system.

19. The direct reduction method of claim 11, wherein the reduction gas received from the reduction/recycle gas loop comprises top gas derived from the direct reduction shaft furnace.

20. The direct reduction method of claim 11, further comprising cleaning and compressing the reduction gas utilizing a scrubber and a compressor disposed in the reduction/recycle gas loop between the direct reduction shaft furnace and the gas heating system.
